(19) United States
(12) Patent Application Publication
(10) Pub. No.: US 2026/0050482 A1
(43) Pub. Date: Feb. 19, 2026

(54) REDUCING EXECUTION TIME OF TASKS IN EDGE ENVIRONMENTS

(71) Applicant: International Business Machines Corporation, Armonk, NY (US)

(72) Inventors: Jing Jing Wei, Beijing (CN); Yue Wang, Beijing (CN); Jia Lin Wang, Beijing (CN); Yi Fan Wu, Beijing (CN); Yang Kang, Beijing (CN)

(21) Appl. No.: 18/807,772

(22) Filed: Aug. 16, 2024

(51) Int. Cl. G06F 9/50; G06F 9/48

(52) U.S. Cl. CPC G06F 9/5038; G06F 9/4881

(57) ABSTRACT

A method, according to one approach, includes: analyzing tasks that are received in an order at an edge node having one or more critical devices. Tags are added to ones of the received tasks that use the critical devices. Moreover, ones of the tagged tasks that use a same one of the critical devices are set as related tasks. The method also includes causing the tagged tasks to be added to an active dependency list. An execution plan is generated for the received tasks based at least in part on the order in which the tasks were received and the dependency list. Furthermore, the received tasks are dispatched to the critical devices as outlined in the execution plan.

### BACKGROUND

The present invention relates to edge nodes, and more specifically, this invention relates to performing tasks at edge nodes.

Increased data production has amplified the overhead associated with data management and processing. While artificial intelligence (AI) has been developed in an attempt to combat this rise in processing overhead, advancements in AI have caused the complexity of machine learning models to increase as well.

Cloud computing has been implemented in an effort to perform computationally intense operations and process an increasing amount of data. For instance, cloud locations can be tailored to provide a dynamic level of computational throughput which adjusts to meet a client's needs. This involves sending all data being analyzed to a centralized location, such as a data center or public cloud location.

Edge computing has also been implemented to extend computing to the endpoints in a system and avoid any reliance on a network to perform processing at a central location. For instance, edge computing allows for data to be processed closer to where it is being generated, allowing for greater processing speeds and volumes. Applications and other types of compute operations are also moved to the edge locations where the data is generated in the interest of data access and security.

### SUMMARY

A method, according to one approach, includes: analyzing tasks that are received in an order at an edge node having one or more critical devices. Tags are added to ones of the received tasks that use the critical devices. Moreover, ones of the tagged tasks that use a same one of the critical devices are set as related tasks. The method also includes causing the tagged tasks to be added to an active dependency list. An execution plan is generated for the received tasks based at least in part on the order in which the tasks were received and the dependency list. Furthermore, the received tasks are dispatched to the critical devices as outlined in the execution plan.

A computer program product, according to another approach, includes: one or more computer-readable storage media. The computer program product also includes program instructions that are stored on the one or more storage media to perform the foregoing method.

A computer system, according to yet another approach, includes: a processor set and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a representational diagram showing a more detailed view of the system of FIG. 2A, in accordance with one approach.

FIG. 3A is a flowchart of a method, in accordance with one approach.

FIG. 3B is a flowchart of sub-operations for one or more of the operations in the method of FIG. 3A, in accordance with one approach.

FIG. 3C is a flowchart of sub-operations for one of the operations in the method of FIG. 3A, in accordance with another approach.

FIG. 3D is a representational view of an original execution order, in accordance with one approach.

FIG. 3E is a representational view of an improved execution order, in accordance with one approach.

FIGS. 4A-4I are tables depicting a progression of performing an improved execution plan, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for improving the process by which tasks are executed in edge computing environments of distributed systems. For instance, by dynamically evaluating tasks as they are received and storing information outlining how the tasks are related to each other (e.g., whether certain tasks involve using the same devices), approaches herein are desirably able to generate an order in which tasks should be performed to satisfy all incoming tasks (e.g., data requests) in a least (e.g., reduced) amount of time. This on-the-fly adaptation is based at least in part on the real-time performance experienced at the edge nodes themselves and/or other locations in a distributed system. This results in the performance improving at each edge node, as well as the system as a whole operating more efficiently, e.g., as will be described in further detail below.

In one general approach, a method includes: analyzing tasks that are received in an order at an edge node having one or more critical devices. Tags are added to ones of the received tasks that use the critical devices. Moreover, ones of the tagged tasks that use a same one of the critical devices are set as related tasks. The method also includes causing the tagged tasks to be added to an active dependency list. An execution plan is generated for the received tasks based at least in part on the order in which the tasks were received and the dependency list. Furthermore, the received tasks are dispatched to the critical devices as outlined in the execution plan.

In another general approach, a computer program product includes: one or more computer-readable storage media. The computer program product also includes program instructions that are stored on the one or more storage media to perform the foregoing method.

In yet another general approach, a computer system includes: a processor set and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved task execution code at block 150 for improving the process by which tasks are executed in edge computing environments of distributed systems. For instance, by dynamically evaluating tasks as they are received and storing information outlining how the tasks are related to each other (e.g., whether certain tasks involve using the same devices), approaches herein are desirably able to generate an order in which tasks should be performed to satisfy all incoming requests in a least (e.g., reduced) amount of time. This on-the-fly adaptation is based at least in part on the real-time performance experienced at the edge nodes themselves and/or other locations in a distributed system. This results in the performance improving at each edge node, as well as the system as a whole operating more efficiently, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

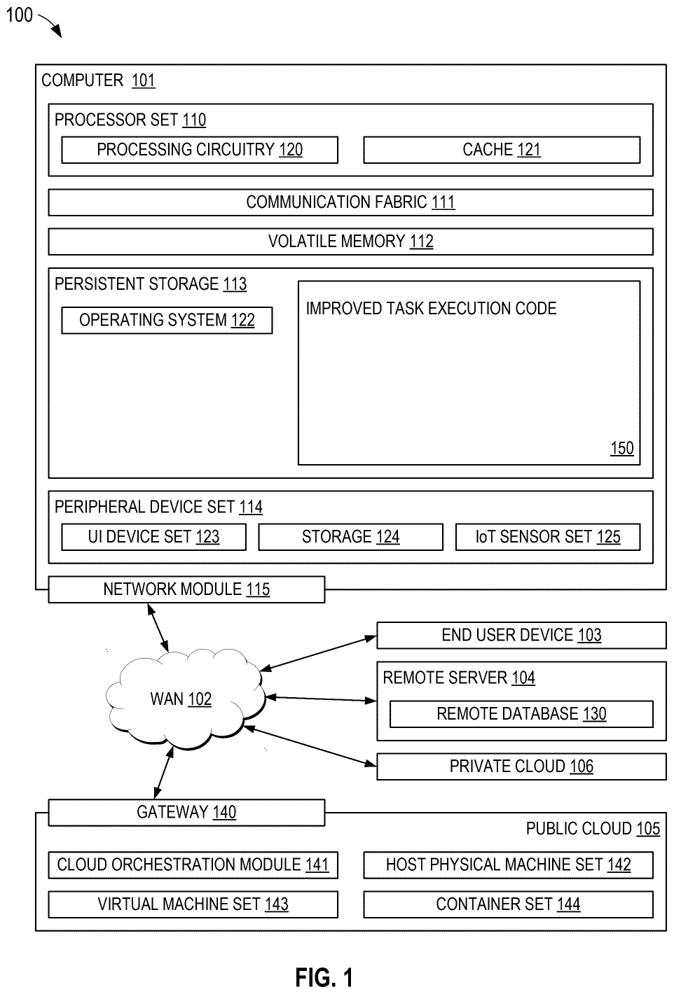

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, increased data production has amplified the overhead associated with data management and processing. While AI has been developed in an attempt to combat this rise in processing overhead, advancements in AI have caused the complexity of machine learning models to increase as well. Increasingly complex machine learning models translate to more intense workloads and increased strain associated with applying the models to received data. The operation of conventional implementations has thereby been negatively impacted.
Cloud computing has been implemented in an effort to improve the ability to perform computationally intense operations and process an increasing amount of data. For instance, cloud locations can be tailored to provide a dynamic level of computational throughput which adjusts to meet a client's needs. While this is effective in preventing processing bottlenecks from developing, it involves sending all data being analyzed to a centralized location, such as a data center or public cloud location. Sending data to a centralized location exposes it to unwanted attacks and unintentional mishandling, thereby significantly increasing the risk of data loss.
In an attempt to combat this reliance on a network to perform all processing at a central location, edge computing has been implemented to extend computing to the endpoints in a system. For instance, edge computing allows for data to be processed closer to where it is being generated, allowing for greater processing speeds and volumes. Applications and other types of compute operations are also moved to the edge locations where the data is generated in the interest of data access and security. For example, data may not be allowed to leave the borders of a particular country to enhance the security and privacy of the data. In another example, a company may prefer to store generated data at an edge location (e.g., “on prem”) such that it is not shared over a network.
While these types of data management schemes are intended to increase throughput, edge locations often have limited resources available to perform various tasks, e.g., at least in comparison to central (e.g., cloud) locations. The performance capabilities of edge locations are thereby affected by fluctuations in different settings, local constraints, demands, etc., which change rapidly over time. According to an example, which is in no way intended to be limiting, KubeEdge is built upon KUBERNETES, and while it supports simplified communication between application and devices, it has also experienced inefficiencies caused by task scheduling conflicts. For instance, in situations where multiple workflows are running on a single edge computing environment, different tasks may involve utilizing the same device. Accordingly, situations arise where there is competition among tasks to use these shared devices (also referred to herein as “critical devices”), ultimately leading to increased latency and task failures experienced at the edge nodes in such conventional products.
In sharp contrast to the foregoing shortcomings experienced by conventional systems, approaches herein are desirably able to improve the process by which tasks are executed in edge computing environments of distributed systems. For instance, by dynamically evaluating tasks as they are received and storing information outlining how the tasks are related to each other (e.g., whether certain tasks involve using the same devices), approaches herein are desirably able to generate an order in which tasks should be performed to satisfy all incoming requests in a least (e.g., reduced) amount of time. This on-the-fly adaptation is based at least in part on the real-time performance experienced at the edge nodes themselves and/or other locations in a distributed system. This results in the performance improving at each edge node, as well as the system as a whole operating more efficiently, e.g., as will be described in further detail below.

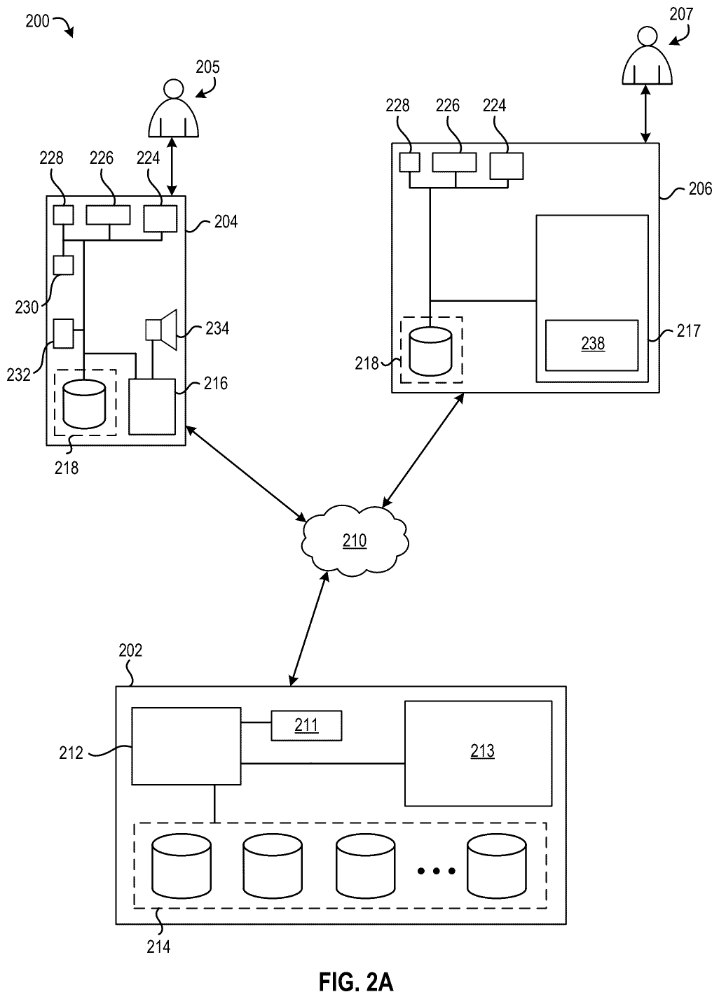

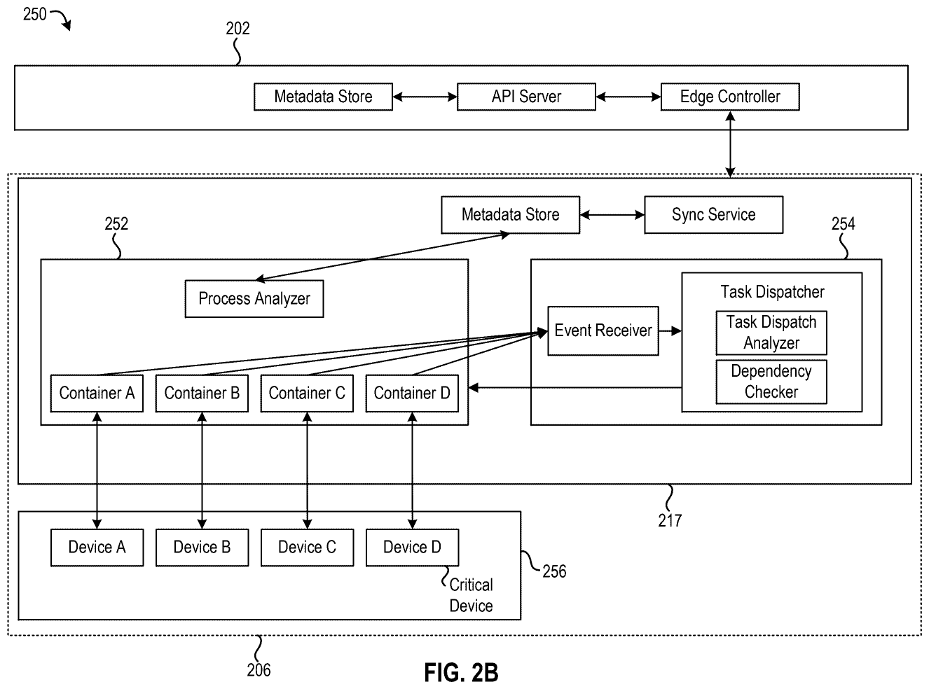

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc. ; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data,” “datasets,” and “information” herein are in no way intended to be limiting either, and may include any desired type of details, e.g., depending on the type of operating system implemented on the user device 204, edge node 206, and/or central server 202.

In some approaches, data that has been generated at, received at, stored at, identified at, etc. the edge node 206 may be kept there for storage and/or processing. As noted above, distributing data storage and/or processing overhead to edge nodes in a distributed system allows for throughput to dramatically increase for the system as a whole, while also reducing latency associated with performing data operations at the edge locations where the data is located. However, edge nodes often have limited resources in comparison to large central (e.g., cloud) locations.

With continued reference to FIG. 2A, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 and/or processor 212 are able to train one or more AI based models. For instance, AI model(s) may be trained in some approaches by evaluating workflows at an edge node over time, applying a predetermined training data set, being retrained with focused datasets to emphasize certain details, etc., in order to learn how to arrange received tasks such that they are performed in an order that takes the least amount of time to complete. In other words, the AI module 213 and/or processor 212 are able to train one or more AI based models to generate execution plans that outline an order in which received tasks (e.g., requests) are performed. Depending on the approach, the execution plans are generated by the AI module 213 and/or processor 212 based at least in part on the order in which the tasks were received and a dependency list developed for the received tasks. This allows for approaches herein to significantly improve the execution time of processes that are performed in edge computing environments of a distributed system, e.g., as will be described in further detail below.

User device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some tasks (e.g., data requests) received from user 205 at edge node 206 involve data stored at edge node 206, and are performed at edge node 206. In other approaches, tasks may be received at central server 202 for implementation at the central server 202. These tasks may be sent to the edge node 206 and/or central server 202 as a result of the user 205 using one or more applications, software programs, temporary communication connections, etc. running on the user device 204. For example, the user 205 may upload data to a local edge node 206 for storage and evaluation therein. As a result, the data is evaluated and processed at the edge node 206.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238.

As described above with respect to AI module 213, the AI module 238 may include any desired number and/or type of AI-based models. It follows that AI module 238 may implement similar, the same, or different characteristics as AI module 213 in central server 202. In some approaches, AI module 238, controller 217, and/or edge node 206 as a whole may be configured to train one or more AI based models to arrange received tasks such that they are performed in an order that takes the least amount of time to complete. In other words, the AI module 238 and/or controller 217 are able to train one or more AI based models to generate execution plans that outline an order in which received tasks (e.g., requests) are performed. For instance, AI model(s) may be trained in some approaches by evaluating workflows at an edge node over time, applying a predetermined training data set, being retrained with focused datasets to emphasize certain details, etc., in order to learn how to arrange received tasks such that they are performed in an order that takes the least amount of time to complete. Again, this allows for approaches herein to significantly improve the execution time of processes that are performed in edge computing environments of a distributed system, e.g., as will be described in further detail below.

Referring momentarily now to FIG. 2B, the system 200 of FIG. 2A is shown in a diagram 250 that depicts more detail according to an illustrative approach which is in no way intended to be limiting. Thus, while certain components in FIG. 2B have common numbering with components in system 200 of FIG. 2A, they may differ in other approaches. It follows that the configuration in FIG. 2B may be implemented in conjunction with features from any other approach listed herein, such as those described with reference to the other FIGS., such as FIG. 2A. However, such diagram 250 and others presented herein may be used in various applications and/or in permutations which may or may not be specifically described in the illustrative approaches listed herein. Further, the diagram 250 presented herein may be used in any desired environment. Thus FIG. 2B (and the other FIGS.) may be deemed to include any possible permutation.

As shown, the central server 202 includes an Edge Controller that at least assists in establishing and/or maintaining a connection between the central server 202 and the controller 217 at edge node 206. The Edge Controller is further connected to an API Server and Metadata Store. The API Server may allow for external applications to connect to the central server 202, e.g., as would be appreciated by one skilled in the art after reading the present description. According to one example, the API Server may be a KUBERNETES based server.

The API Server in central server 202 is also connected to a Metadata Store which includes a variety of metadata associated with how workflow is performed at the edge node. In other words, the Metadata Store may include process templates which include information that outlines how various tasks are related to each other. In some approaches, the Metadata Store receives dependency lists that have been developed at the edge node 206 (e.g., by one or more trained AI based models) and which outline a general order in which various tasks (e.g., operations) are performed to achieve a desired result, e.g., such as completing a running process.

Looking now to controller 217, a Sync Service module is used to monitor traffic received from central server 202. In some approaches the Sync Service module is configured to identify and/or merge various tasks from traffic received in real-time. Information received by Sync Service module is passed along to Metadata Store. There desired information may be extracted, stored, used to perform AI based model training and/or retraining, etc. According to some approaches, the Metadata Store develops dependency lists that summarize the relationships between various tasks that may be received over time.

The Metadata Store is further connected to Process Analyzer in edge agent 252. In some approaches, the Process Analyzer receives process templates, dependency lists, and/or other information from Metadata Store that outlines how various tasks are related to each other. The Process Analyzer may thereby be configured to evaluate received tasks and determine whether any of the received tasks involve using a same device and/or critical device. The edge agent 252 additionally includes a number of containers (Container A, Container B, Container C, and Container D), each of which may be used to run a different task. Ideally, each of the containers in edge agent 252 run a task that is actually performed using a different physical device at the edge node 206. As shown in FIG. 2B, parallel throughput is maximized by correlating each of the containers (Container A, Container B, Container C, and Container D) with a respective one of the physical devices (Device A, Device B, Device C, and Device D) in device module 256.

However, situations arise in which different tasks utilize the same physical device. For instance, two or more of the containers may attempt to access a same one of the physical devices (Device A, Device B, Device C, and Device D), leading to performance delay if left unchecked. Each of the containers (Container A, Container B, Container C, and Container D) are thereby connected to Event Receiver of eventing module 254. The Event Receiver is responsible for receiving events (e.g., tasks) from the various containers and organizing them before being sent to the Task Dispatcher. The Event Receiver may also receive tasks directly from users, the central server 202, applications running at edge node 206, etc.

Task Dispatcher uses the Task Dispatch Analyzer along with the Dependency Checker to evaluate the various tasks that are provided by the Event Receiver. For instance, the Task Dispatcher evaluates the received tasks and tags ones of the received tasks that involve using one or more critical devices in comparison to non-critical devices. For example, Device D may be a critical device, while Device A, Device B, and Device C are each non-critical devices (e.g., that may be used interchangeably for at least some tasks). Moreover, received tasks that involve using a same critical device may be identified as related tasks. As noted above, a “critical device” is intended to refer to a physical (or logical) device that is involved with (e.g., required for) performing certain tasks. Thus, in some approaches, a critical device may be a device that is merely predefined as being involved with performing one or more particular tasks. In preferred approaches, a critical device is one that is required for performing one or more particular tasks. In some approaches, a critical device may be one that is not only involved with performing a plurality of particular tasks, but is a shared device that creates a bottleneck when its performance for one task impacts the processing and/or performance of another task. According to an example, Device D at edge node 206 may be a lone data encryptor that is considered a critical device, as it becomes a bottleneck for related tasks that involve encrypting and/or decrypting data at the edge node using the same data encryptor. In another example, Device D at edge node 206 may be a lone data compressor that is considered a critical device, as it becomes a bottleneck for related tasks that involve compressing and/or decompressing data at the edge node using the same data compressor. Situations arise where there is competition among tasks to use these same critical devices that are shared by multiple different containers. While conventional products have experienced increased latency and task failures at edge nodes as a result, approaches herein are again able to desirably determine a most efficient order in which various tasks should be performed, thereby improving efficiency at edge nodes.

In sharp contrast to these conventional shortcomings, the Task Dispatcher of FIG. 2B is able to generate improved execution plans for tasks as they are received. For instance, the Task Dispatch Analyzer may evaluate the order that the tasks were received as well as dependency lists developed for tasks performed at edge node 206, while generating the order in which the particular set of received tasks is performed to minimize latency. In some approaches, the Task Dispatcher uses one or more trained AI based models to evaluate the available dependency lists, workflows, past performance, etc., and generate improved execution plans. This results in the performance improving at edge node 206, e.g., as will be described in further detail below.

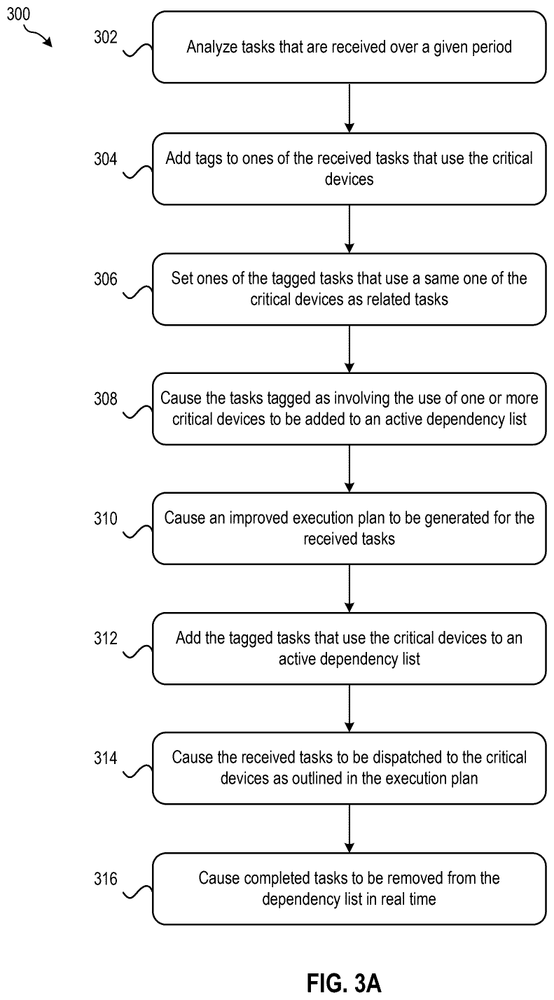

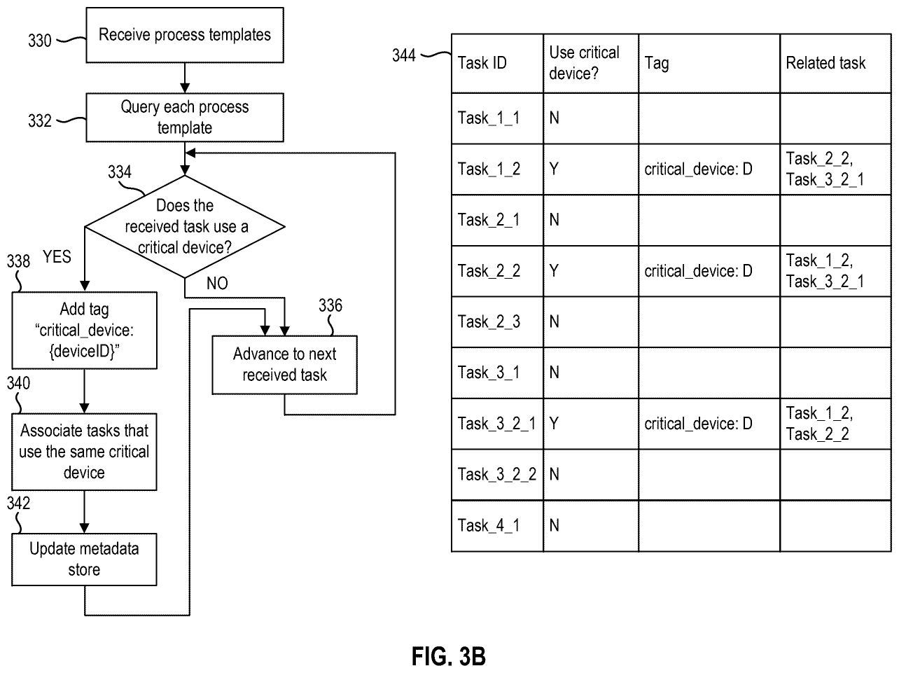

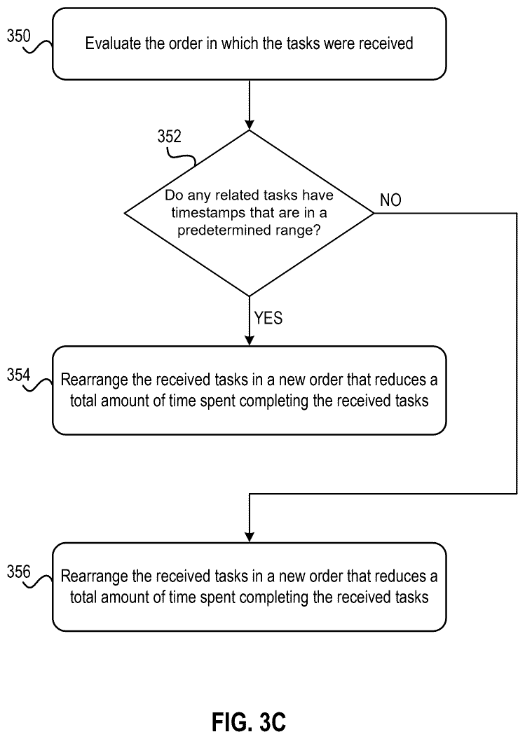

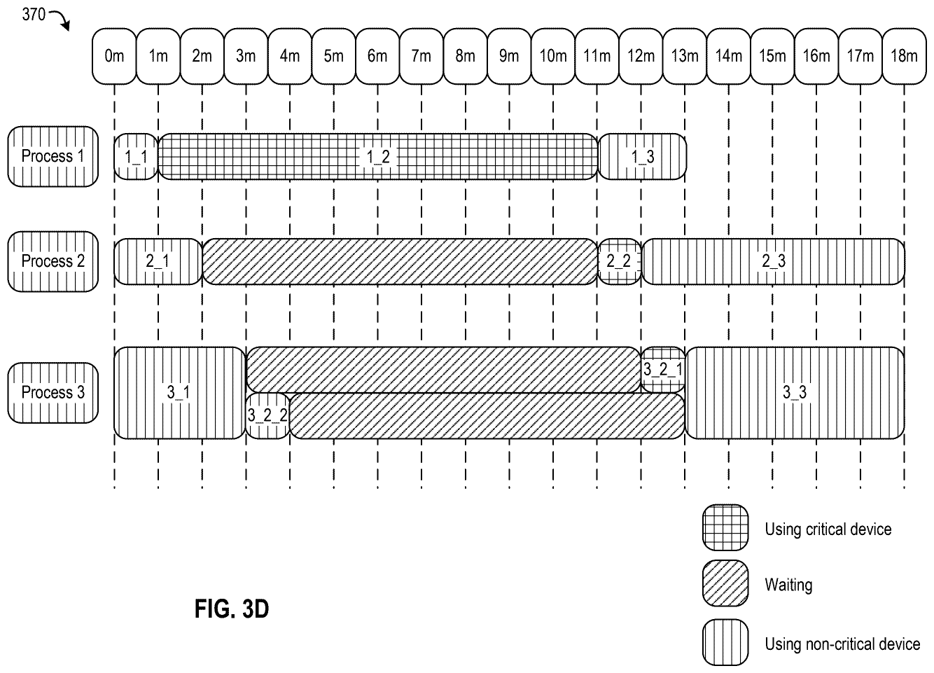

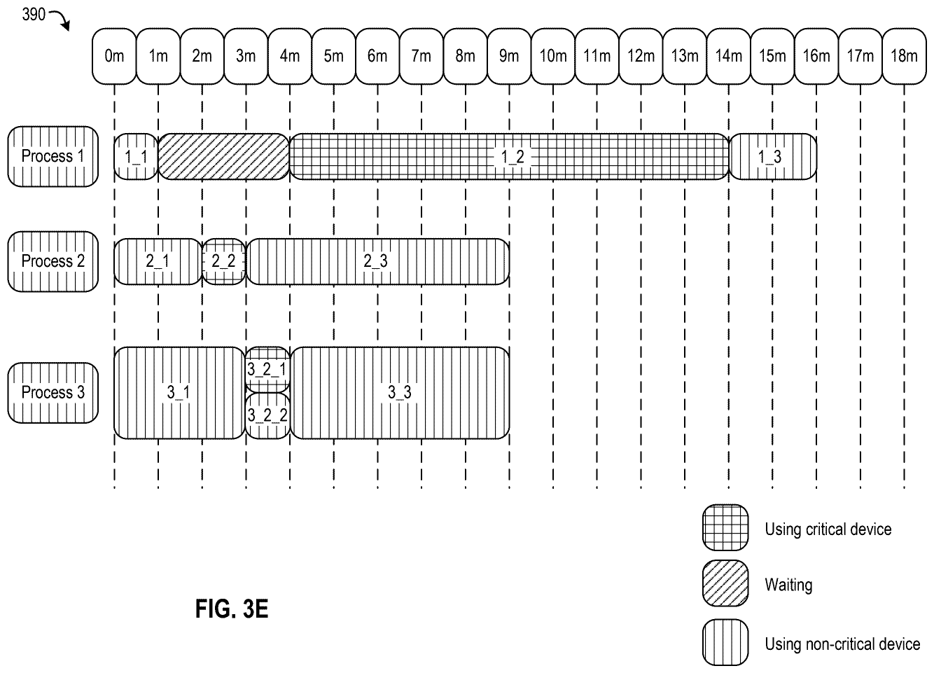

Looking now to FIG. 3A, a flowchart of a method 300 for providing an informed process of improving the execution time of processes in edge computing environments of a distributed system is illustrated in accordance with one approach. Specifically, method 300 involves dynamically evaluating tasks that are received, and generating an order in which the received set of tasks is performed to minimize latency and improve efficiency. In some approaches, this involves evaluating the real-time performance at the edge nodes themselves. This results in the performance improving at each edge node, as well as the system as a whole operating more efficiently, e.g., as will be described in further detail below.

The method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in various approaches, the method 300 may be partially or entirely performed by a controller, a processor, a computer, etc., or some other device having one or more processors therein. Thus, in some approaches, method 300 may be a computer-implemented method. Moreover, the terms computer, processor and controller may be used interchangeably with regards to any of the approaches herein, such components being considered equivalents in the many various permutations of the present invention.

Accordingly, in some approaches at least some of the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to organize received tasks in such a way that performance time (e.g., latency) is reduced while also ensuring the tasks are performed. Predetermined training data sets may also be applied to learn how to automatically generate an order in which tasks should be performed to satisfy all incoming requests in a least (e.g., reduced) amount of time.

Initial training may include reward feedback that may, in some approaches, be implemented using a subject matter expert (SME) that generally understands related tasks. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing at least some of the techniques and/or operations of method 300 may be performed. In some further approaches, the AI model may be a neuromyotonic AI model that may improve performance of computer devices in an infrastructure associated with performing tasks at edge nodes, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from an environment. Such an AI model ensures that each received task is evaluated and adjusted accordingly to achieve improved performance, where the scale of such analysis and determinations would not otherwise be feasible for a human to perform, much less in real-time as various tasks are received and/or generated at an edge node. This is because humans are not able to efficiently do so, and would otherwise incorporate processing delays and errors in the process of performing the approaches included herein. Accordingly, management of operations described herein is not able to be achieved by human manual actions.

Moreover, for those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Looking to method 300, operation 302 includes analyzing tasks that are received over a given period. For instance, the order in which the tasks are received is stored and evaluated in order to determine a desired order in which the received tasks should actually be performed. In some approaches, tasks received at the edge node are analyzed using a process analyzer at the edge node. As noted above, tasks received in operation 302 may include data operations or any other processes involving data located at an edge node. Moreover, the tasks may be received from applications running locally at the edge node, users, remote applications running at a central location, etc., depending on the approach.

From operation 302, method 300 proceeds to operation 304. There, operation 304 includes adding tags to ones of the received tasks that use the critical devices. Moreover, operation 306 includes setting ones of the tagged tasks that use a same one of the critical devices as related tasks. In other words, operation 304 includes inspecting each of the received tasks and taking ones that involve the use of one or more critical devices, while operation 306 includes inspecting the tagged tasks and identifying ones that involve using the same critical device. Once again, a “critical device” is intended to refer to a physical (or logical) device that is involved with (e.g., required for) performing certain tasks. Situations arise where there is competition among tasks to use these same critical devices. While conventional products have experienced increased latency and task failures at edge nodes as a result, approaches herein are again able to desirably determine a most efficient order in which various tasks should be performed, thereby improving efficiency at edge nodes.

Referring momentarily now to FIG. 3B, exemplary sub-operations of tagging received tasks that involve using critical devices and identifying tagged tasks that involve using the same critical device, are illustrated in accordance with one approach. It follows that one or more of these sub-operations may be used to perform operation 304 and/or 306 of FIG. 3A. However, it should be noted that the sub-operations of FIG. 3B are illustrated in accordance with one approach which is in no way intended to be limiting. For instance, FIG. 3B also illustrates a table 344 that may be formed as a result of performing one or more of the sub-operations in FIG. 3B. For instance, the table 344 outlines an exemplary list of tasks processed with the sub-operations in FIG. 3B. As shown, the table 344 reflects whether each task involves using a critical device, the specific critical device associated with tasks that do involve using one, as well as any related tasks that may involve using the same critical device(s), e.g., as described in further detail below.

As shown, sub-operation 330 includes receiving process templates from a metadata store at the edge node. In some approaches a process analyzer receives the process templates from the metadata store. Moreover, the process templates may include information that outlines how various tasks are related to each other (e.g., such as process definitions). In some approaches, a process analyzer may receive the process templates along with dependency lists that have been developed at the edge node (e.g., by one or more trained AI based models) and which outline a general order in which various tasks (e.g., operations) are performed to achieve a desired result, e.g., such as completing a running process.

From sub-operation 330, the flowchart proceeds to sub-operation 332. There, sub-operation 332 includes querying each of the received process templates with respect to the tasks received in operation 302 of FIG. 3A above. In preferred approaches, sub-operation 332 includes evaluating each of the process templates and determining whether each of the received tasks utilize a critical device. Accordingly, sub-operation 334 includes determining whether each of the received tasks use a critical device.

In response to determining that a given one of the received tasks does not use a critical device, the flowchart is shown as proceeding to sub-operation 336. There, sub-operation 336 includes advancing to a next one of the received tasks for evaluation, before returning to sub-operation 334. It follows that each of the received tasks may be evaluated with respect to one or more process templates. One or more of the sub-operations in FIG. 3B may be repeated any desired number of times, e.g., to evaluate any desired number of received tasks.

Returning to sub-operation 334, the flowchart advances to sub-operation 338 in response to determining that a given (present) one of the received tasks does involve using a critical device. There, sub-operation 338 includes adding a tag to the given task. According to an example, which is in no way intended to be limiting, the tag may include “critical_device:{deviceID}”, where the deviceID is preferably correlated with the respective critical device. Thus, the received task is essentially tagged with a unique identifier that corresponds to the critical device associated with performing the given task.

From sub-operation 338, the flowchart advances to sub-operation 340. There, sub-operation 340 includes associating ones of the tagged tasks that use the same critical device. In other words, sub-operation 340 includes inspecting each of the tagged tasks and identifying ones that involve using the same critical device. For example, an additional tag may be applied to tagged tasks that use the same critical device, a lookup table may be formed that identifies tagged tasks that use the same critical devices, etc.

From sub-operation 340, the flowchart advances to sub-operation 342. There, sub-operation 342 includes updating metadata stores to reflect the tasks identified (e.g., tagged) in sub-operations 338 and 340. In other words, sub-operation 342 includes updating the repositories that store the process templates used to evaluate incoming tasks. The flowchart further advances from sub-operation 342 to sub-operation 336. As noted above, sub-operation 336 advances to a next one of the tasks received in operation 302 before returning to sub-operation 334. Again, one or more of the sub-operations in FIG. 3B may be repeated for each of the received tasks, e.g., as would be appreciated by one skilled in the art after reading the present description.

Returning now to FIG. 3A, method 300 advances from operation 306 to operation 308. There, operation 308 includes causing the tasks tagged as involving the use of one or more critical devices to be added to an active dependency list. In other words, operation 308 includes creating a structured collection of information (e.g., data) that accurately reflects operational relationships between the tagged (e.g., related) tasks (e.g., see FIG. 3B). In some approaches, operation 308 is performed at least in part using a task dispatch analyzer (e.g., see FIG. 2B).

Referring still to FIG. 3A, method 300 advances from operation 308 to operation 310. There, operation 310 includes causing an improved execution plan to be generated for the received tasks. In other words, operation 310 includes sending one or more instructions that result in an improved execution plan being generated. In some approaches, the one or more instructions are sent to a task dispatch analyzer which generates the execution plan based at least in part on the order in which the tasks were originally received and any associated dependency lists. For instance, a determination may be made as to whether a given task has any dependencies (e.g., is referenced by any other tasks). In response to determining a given task does have one or more dependencies, the task in question is not immediately dispatched. However, the task is dispatched in response to determining a given task does not have any dependencies. The task dispatch analyzer may include one or more AI based models that have been trained to reduce (e.g., minimize) a total amount of time spent completing the received tasks.

Referring now to FIG. 3C, exemplary sub-operations of dynamically generating an improved execution plan for a set of received tasks, are illustrated in accordance with one approach. It follows that one or more of these sub-operations may be used to perform operation 310 of FIG. 3A. However, it should be noted that the sub-operations of FIG. 3C are illustrated in accordance with one approach which is in no way intended to be limiting.

As shown, sub-operation 350 includes evaluating the order in which the tasks were received. In other words, sub-operation 350 includes inspecting the specific order in which the tasks were received and arranging them in a corresponding arrangement to be performed. As noted above, tasks may be received from running applications in some approaches, thereby causing the tasks to be received in a specific order. For example, referring momentarily to FIG. 3D, tasks associated with different processes are arranged in an execution plan 370 that represents the order in which the tasks were received. As shown, this may lead to situations where one or more of the processes are waiting (e.g., idle) an unnecessarily long time.

Returning to FIG. 3C, sub-operation 352 includes making a determination as to whether any of the related tasks have timestamps that are in a predetermined range of each other. In other words, sub-operation 352 includes determining whether any tasks that involve the use of the same critical device(s) are received (and thereby positioned in a resulting queue) in a given window of time. Depending on the approach, the predetermined range may be between 0 minutes and about 10 minutes, more preferably between 0 minutes and about 5 minutes, still more preferably between 0 minutes and about 3 minutes. For example, referring again momentarily to FIG. 3D, the tasks received in an 18 minute window are arranged in the execution plan 370 with a same order as they were received. It follows that the tasks associated with each time slot in the 18 minute window may be compared to determine whether any related (e.g., tagged) tasks are overlapping and/or within a predetermined range of each other. As shown, the execution plan 370 includes tasks 2_2 and 3_2_1 positioned in a same 2 minute window. Thus, while task 2_2 is scheduled to initiate at minute 11, task 3_2_1 is scheduled to initiate at minute 12, which may be in the predetermined range.

In response to determining that one or more of the received tasks are scheduled to be performed sufficiently close to each other, the flowchart proceeds from sub-operation 352 to sub-operation 354. There, sub-operation 354 includes rearranging the received tasks in a new order that reduces a total amount of time spent completing the received tasks. In other words, sub-operation 354 includes generating an improved execution plan that increases the efficiency by which the received tasks can be performed at a given edge node. As node above, the improved execution plan may be generated using one or more trained AI based models. However, any approaches herein may be implemented in sub-operation 354 to generate an improved execution plan.

Referring momentarily to FIG. 3E, the same tasks included in the execution plan 370 of FIG. 3D have been rearranged into an improved execution plan 390. This improved execution plan 390 reduces the total amount of time associated with performing each of the received tasks. As shown, the improved execution plan 390 completes each of the received tasks in a total of 16 minutes, while the original execution plan 370 of FIG. 3D performed the tasks in 18 minutes. Processes associated with the various tasks are also performed in the improved execution plan 390 with significantly less waiting (e.g., idle) time in comparison to execution plan 370.

However, returning to sub-operation 352 of FIG. 3C, the flowchart is alternatively seen as advancing to sub-operation 356 in response to determining that the received tasks are not scheduled to be performed sufficiently close to each other. There, sub-operation 356 includes performing the tasks in a same order as they were received. In other words, the tasks are performed without rearranging their order.

It should be noted that while sub-operation 352 is described above as depending on whether related tasks are arranged sufficiently close to each other in an execution plan, deciding to rearrange the received tasks may be based on additional factors. For example, in some approaches a determination may be made as to whether the total number of related (and tagged) tasks received is outside a predetermined range (e.g., above a threshold). In other approaches, a determination may be made as to whether received tasks correspond to specific critical devices, etc.

Returning now again to FIG. 3A, method 300 advances from operation 310 to operation 312. There, operation 312 includes adding the tagged tasks that use the critical devices to an active dependency list. In other words, operation 312 includes updating existing dependency lists to indicate the tasks that involve using one or more critical devices. In some approaches, this is achieved by sending one or more instructions to a task dispatch analyzer. This desirably allows for an accurate understanding of how certain tasks relate to each other.

Method 300 further advances to operation 314 from operation 312. There, operation 314 includes causing the received tasks to be dispatched to the critical devices as outlined in the execution plan. In other words, operation 314 includes sending one or more instructions to a task dispatcher, the one or more instructions being configured to cause the task dispatcher to issue the tasks to the corresponding physical and/or logical devices as outlined in the improved execution plan. In some approaches, the task dispatcher may correlate containers at the edge node with the critical devices and/or other “non-critical” devices at the edge node. These containers may allow for interactions to be made between the critical and non-critical devices, and the corresponding tasks to be completed by being dispatched thereto.

Method 300 advances to operation 316 from operation 314. There, operation 316 includes causing completed tasks to be removed from the dependency list in real time. This allows for tagged tasks to be disregarded as soon as they have been completed, freeing up throughput to perform additional tasks. In some approaches, completed tasks are removed from the dependency list using a dependency checker during runtime. For instance, removing a completed task from the dependency list involves determining whether the completed task is referenced in the dependency lists of any other tasks. In situations where a completed task is referenced in the dependency list of another task, the reference to the completed task is also removed, e.g., as will soon become apparent.

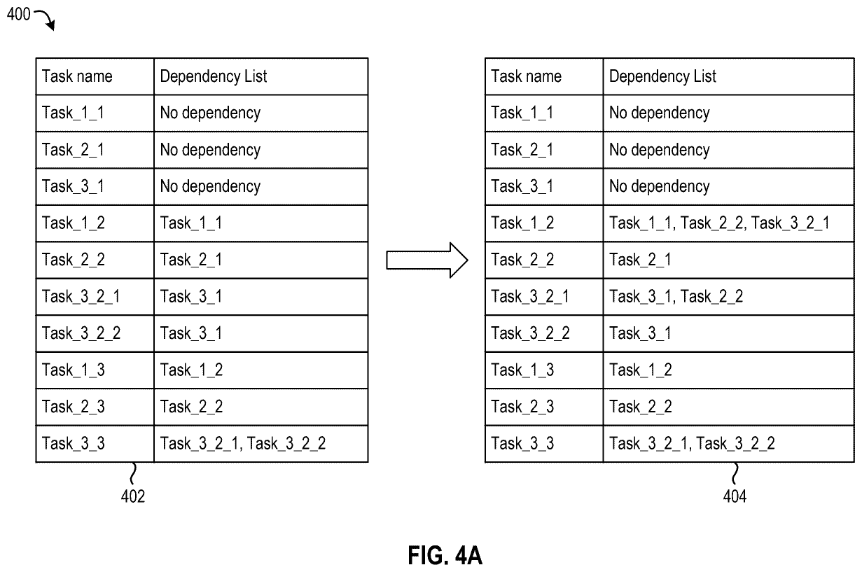

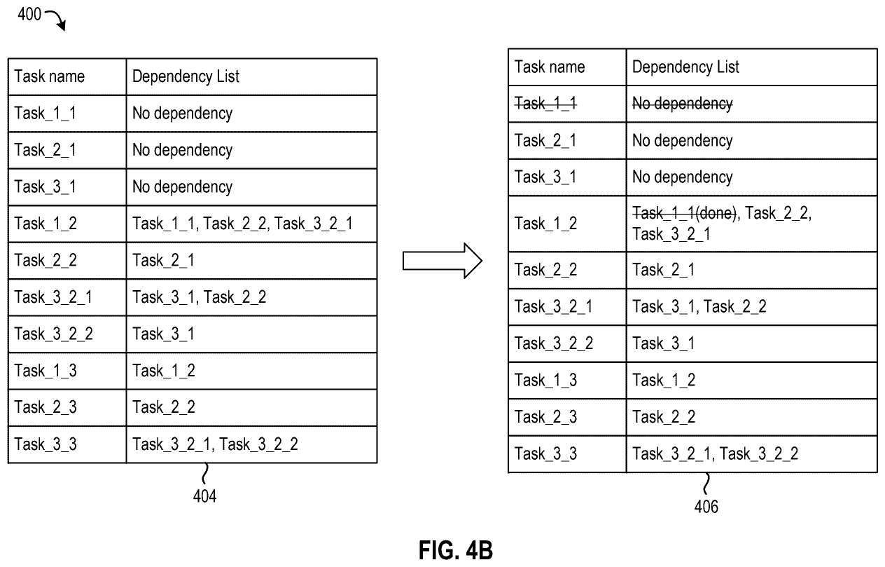

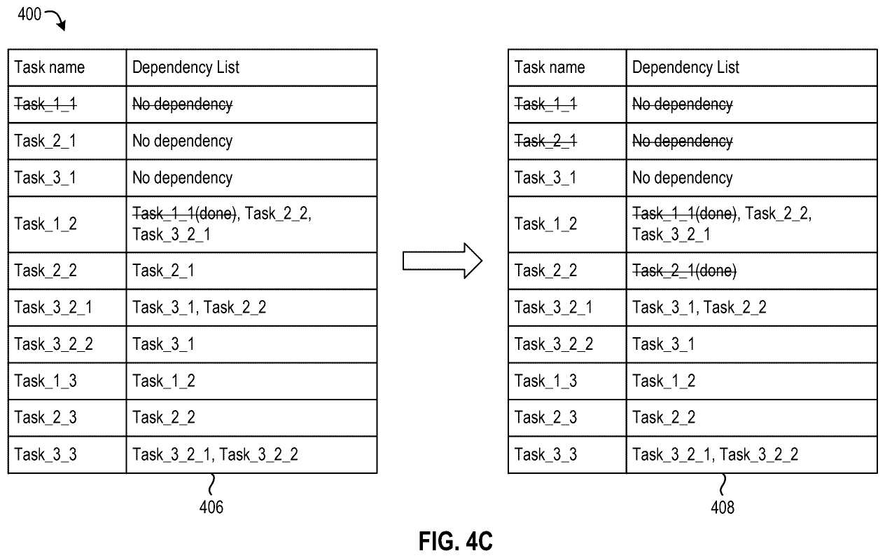

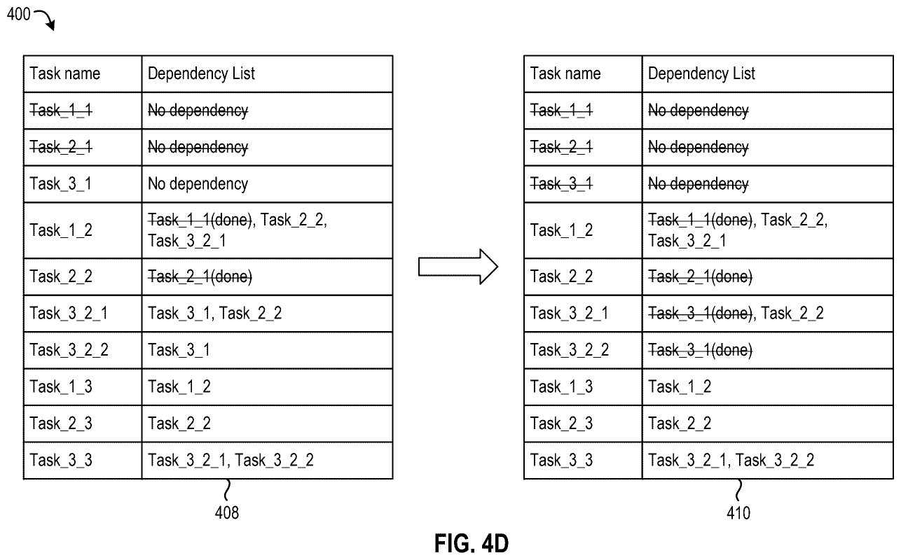

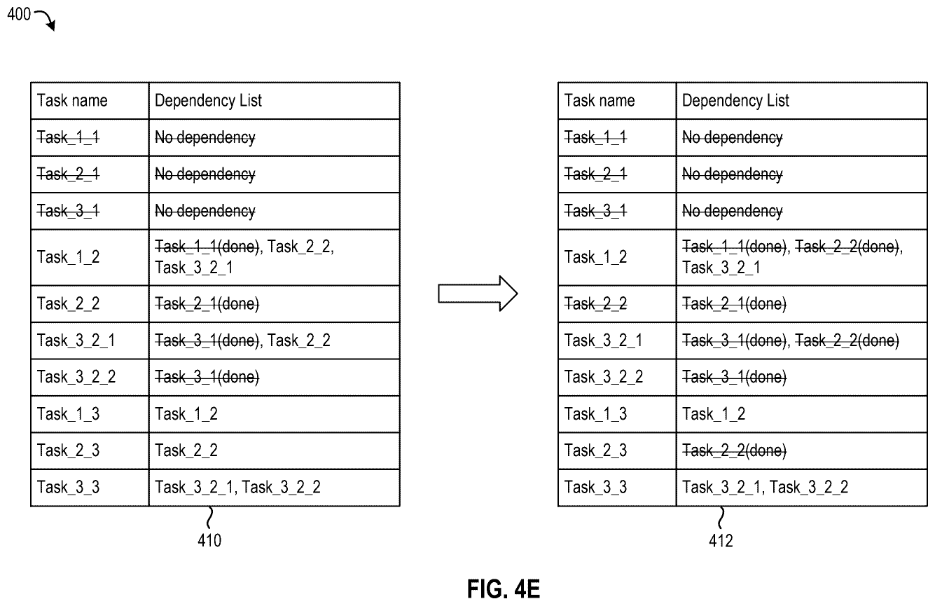

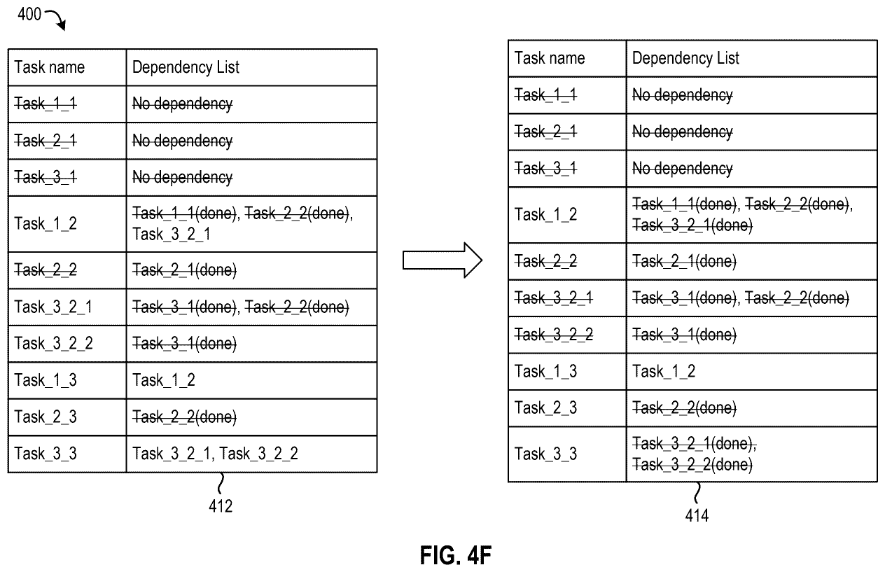

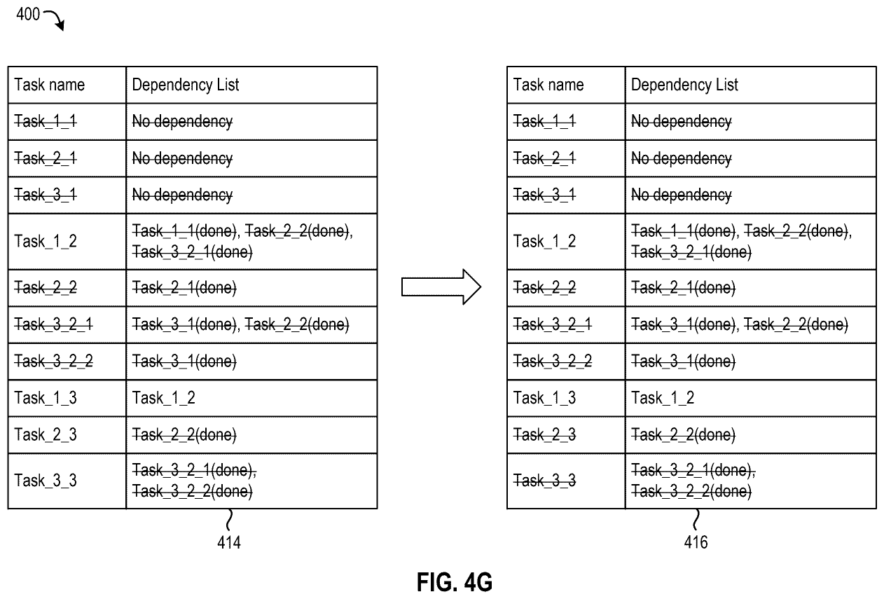

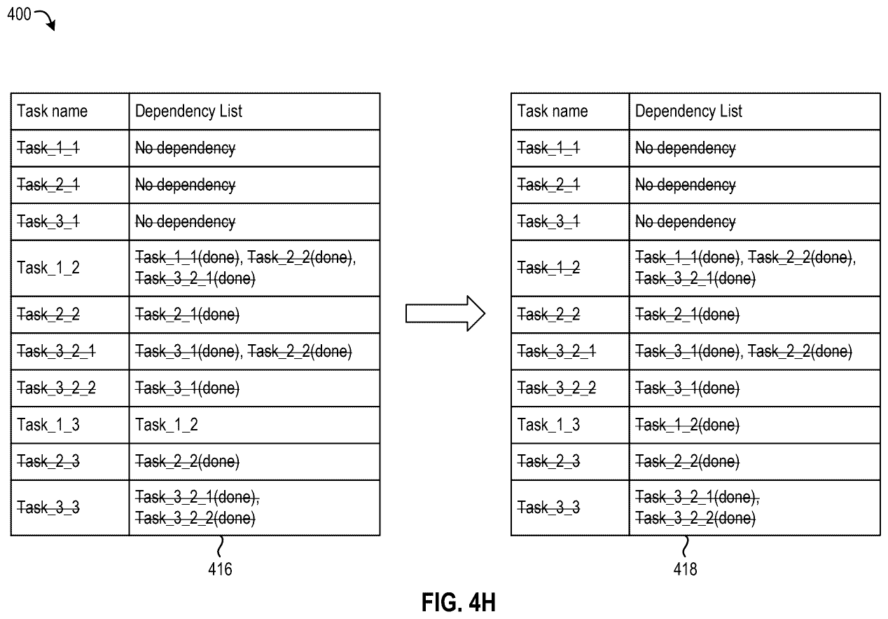

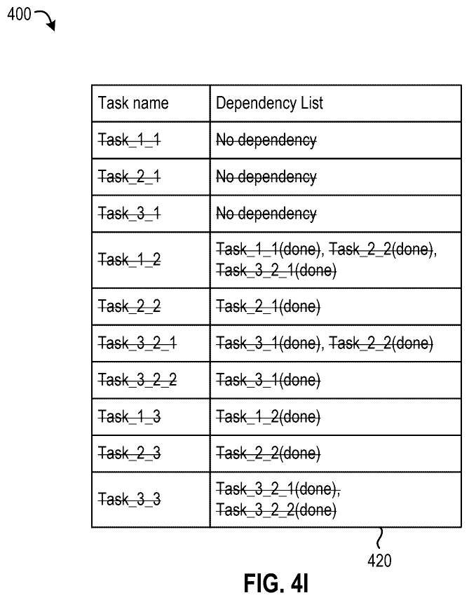

Looking now to FIGS. 4A-4I, an illustrative progression 400 of performing the improved execution plan 390 of FIG. 3E is shown in accordance with an in-use example which is in no way intended to be limiting. For instance, the in-use example is illustrated in FIGS. 4A-4I in the context of how an active dependency list is updated during the process of replacing an original execution plan and satisfying various tasks as outlined in the improved execution plan. The process of performing various tasks as described herein may thereby combine the illustrative progression 400 of FIGS. 4A-4I with aspects of the system in FIGS. 3A-3B, e.g. as would be appreciated by one skilled in the art after reading the present description.

Looking first to FIG. 4A, the original dependency list 402 corresponds to an original order in which tasks are received over a given period. For instance, the original dependency list 402 represents the operational relationships that exist between the tasks in the original execution plan 370 of FIG. 3D. However, after evaluating the various tasks and generating improved execution plans that satisfy the received tasks more efficiently, the original dependency list 402 is updated, creating a new dependency list 404. This new dependency list 404 reflects the new operational relationships between the tasks as they have been rearranged in the improved execution plan 390 of FIG. 3E.

Advancing to FIG. 4B, Task_1_1 is performed after being identified as an initial task in the improved execution plan at the outset. In response to Task_1_1 being completed, the new dependency list 404 is updated to reflect this information. Accordingly, dependency list 406 is shown as having Task_1_1 removed and/or indicated as having been completed. For instance, a dependency checker may be used to delete the Task_1_1 row, as well as removing Task_1_1 from the dependency list of Task_1_2. Furthermore, a task dispatcher does not dispatch Task_1_2 next, because its dependency list is not empty. Although not shown, in some approaches, a dependency list may also be updated to indicate tasks that failed or otherwise were not completed successfully.

Proceeding to FIG. 4C, Task_2_1 is subsequently performed. Moreover, dependency list 408 indicates that Task_2_1 has been completed. In addition to removing Task_2_1 from the Task name column, the dependency list 408 also removes Task_2_1 from the Dependency List column. In other words, the dependency list 408 is updated to remove tasks from dependency chains, thereby allowing for related (e.g., dependent) tasks to be completed without considering tasks that have already been completed. Moreover, a task dispatcher dispatches Task_2_2 because its dependency list is empty.

Accordingly, FIG. 4D shows that the progression advances to Task_3_1 and completes it. As noted above, the dependency list 410 is updated again to indicate that Task_2_1 has been completed, including additional instances in the Dependency List itself. A dependency checker may be used to delete the Task_3_1 row, as well as remove Task_3_1 from the dependency list of Task_3_2_1 and Task_3_2_2, e.g., as shown in dependency list 410. Moreover, a task dispatcher dispatches Task_3_2_2 because its dependency list is empty. However, the task dispatcher does not dispatch Task_3_2_1 because its dependency list is not empty.

Looking now to FIG. 4E, Task_2_2 is a next task performed in the progression of completing the improved execution plan. Accordingly, the updated dependency list 412 indicates that Task_2_2 has been completed, before advancing to a next task. Accordingly, a dependency checker may be used to delete the Task_2_2 row, as well as remove Task_2_2 from the dependency list of Task_3_2_1 and Task_2_3. A task dispatcher may also dispatch Task_3_2_1 and/or Task_2_3 because their respective dependency lists are empty.

As seen in FIG. 4F, the improved execution plan involves advancing to Task_3_2_1 and Task_3_2_2 which are both performed in parallel. For instance, Task_3_2_1 and Task_3_2_2 are not related tasks (do not involve using the same critical device(s)) and therefore may be performed by two different devices. Accordingly, Task_3_2_1 and Task_3_2_2 are both removed from the updated dependency list 414 after being successfully completed.

It follows that a dependency checker may be used to delete the Task_3_2_1 and Task_3_2_2 rows. The dependency checker may also remove Task_3_2_1 from the dependency list of Task_3_3 and Task_1_2. The dependency checker further removes Task_3_2_2 from the dependency list of Task_3_3. Moreover, a task dispatcher may be used to dispatch Task_3_3 and/or Task_1_2 because their respective dependency lists are empty.

Furthermore, FIG. 4G shows that after Task_3_2_1 and Task_3_2_2 are completed, the progression advances to Task_2_3 and Task_3_3 (as outlined in the improved execution plan) which are also performed at least partially in parallel. In response to successfully completing Task_2_3 and Task_3_3, they are removed from the updated dependency list 416. In some approaches, a dependency checker may be used to delete the Task_2_3 and Task_3_3 rows. FIG. 4H further illustrates that the progression next advances to Task_1_2 which involves using at least one critical device as outlined in the improved execution plan. A dependency checker may be used to delete the Task_1_2 row. The dependency checker may also be used to remove Task_1_2 from the dependency list of Task_1_3. Furthermore, a task dispatcher may be used to dispatch Task_1_3 because its dependency list is empty, e.g., as shown.

Finally, FIG. 4I shows that Task_1_3 is completed and removed from the now completed (e.g., empty) dependency table 420. As a result, the improved execution plan has caused all received tasks to have been completed more efficiently than the tasks as they were originally received and ordered. In other words, the progression of FIGS. 4A-4I is achieved more efficiently than if the tasks had been performed in a different order, e.g., as described herein.

Again, approaches herein are desirably able to reduce completion time of multiple processes, improve the utilization rate of critical device and ensure the success rate of processes. These improvements are achieved by approaches herein at least in part because process analyzers are added in edge environments (e.g., nodes) to analyze process definitions of workflow, and adds tag on the tasks that use critical devices. The process analyzer is also able to set all tasks that use the same critical device to be related tasks and generate dependency list. Approaches herein also utilize task dispatch analyzers which generate improved (e.g., optimized) execution plans for received tasks. The task dispatch analyzer may also be configured to add new dependencies for tasks that use critical device in dependency list. A task dispatcher may further be used to dispatch tasks to a device not only based on the order in which the tasks were originally received, but also based on dependency lists, e.g., as described herein. Furthermore, a dependency checker may be used in approaches herein to remove completed tasks from dependency lists in real-time, e.g., during processes running.

Approaches herein are again able to effectively solves a special problem in edge computing environments, that is typically not relevant to central cloud environments that have more robust resources. These approaches are able to reduce completion time of multiple processes, improve the utilization rate of critical device, and ensure the success rate of processes. Approaches herein also perform more efficiently than conventional implementations, e.g., by generating execution plans that improve the order in which tasks are executed from a business perspective. Approaches takes advantage of the characteristics of the process: the process has a defined process template, the system can know in advance which tasks will use the critical device, and the process definition can be used as a reference for analysis to optimize the device utilization.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method, comprising:
analyzing tasks received in an order at an edge node having one or more critical devices;
adding tags to ones of the received tasks that use the critical devices;
setting ones of the tagged tasks that use a same one of the critical devices as related tasks;
causing the tagged tasks to be added to an active dependency list;
causing an execution plan to be generated for the received tasks based at least in part on the order in which the tasks were received and the dependency list; and
causing the received tasks to be dispatched to the critical devices as outlined in the execution plan.

2. The method of claim 1, wherein the execution plan is generated for the received tasks using a task dispatch analyzer having one or more AI based models trained to reduce a total amount of time spent completing the received tasks.

3. The method of claim 1, wherein the analyzing the tasks received at the edge node comprises:
receiving, by a process analyzer, process templates from a metadata store at the edge node; and
determining whether the tasks in the process templates use the critical devices.

4. The method of claim 1, wherein the causing the execution plan to be generated for the received tasks comprises:
evaluating the order in which the tasks were received;
determining whether any of the related tasks have timestamps that are in a predetermined range of each other; and
in response to determining that two or more of the related tasks have timestamps that are in the predetermined range, rearranging the received tasks in a new order that reduces a total amount of time spent completing the received tasks.

5. The method of claim 4, wherein the predetermined range is between 0 minutes and about 5 minutes.

6. The method of claim 4, wherein the causing the received tasks to be dispatched to the critical devices as outlined in the execution plan comprises:
sending one or more instructions to a task dispatcher, the one or more instructions being configured to cause the task dispatcher to:
correlate containers at the edge node with the critical devices and/or other devices at the edge node, and
dispatch the received tasks to the containers in the new order.

7. The method of claim 6, further comprising:
in response to one or more of the tagged tasks being completed, causing the respective tagged tasks to be removed from the dependency list in real time.

8. The method of claim 1, wherein the dependency list reflects relationships between the related tasks.

9. The method of claim 1, wherein the edge node is connected to a cloud location having an edge controller and an API server.

10. A computer program product, comprising:
one or more computer-readable storage media; and
program instructions stored on the one or more storage media to perform operations comprising:
analyzing tasks received in an order at an edge node having one or more critical devices;
adding tags to ones of the received tasks that use the critical devices;
setting ones of the tagged tasks that use a same one of the critical devices as related tasks;
causing the tagged tasks to be added to an active dependency list;
causing an execution plan to be generated for the received tasks based at least in part on the order in which the tasks were received and the dependency list; and
causing the received tasks to be dispatched to the critical devices as outlined in the execution plan.

11. The computer program product of claim 10, wherein the execution plan is generated for the received tasks using a task dispatch analyzer having one or more AI based models trained to reduce a total amount of time spent completing the received tasks.

12. The computer program product of claim 10, wherein the analyzing the tasks received at the edge node comprises:
receiving, by a process analyzer, process templates from a metadata store at the edge node; and
determining whether the tasks in the process templates use the critical devices.

13. The computer program product of claim 10, wherein the causing the execution plan to be generated for the received tasks comprises:
evaluating the order in which the tasks were received;
determining whether any of the related tasks have timestamps that are in a predetermined range of each other; and
in response to determining that two or more of the related tasks have timestamps that are in the predetermined range, rearranging the received tasks in a new order that reduces a total amount of time spent completing the received tasks.

14. The computer program product of claim 13, wherein the predetermined range is between 0 minutes and about 5 minutes.

15. The computer program product of claim 13, wherein the causing the received tasks to be dispatched to the critical devices as outlined in the execution plan comprises:
sending one or more instructions to a task dispatcher, the one or more instructions being configured to cause the task dispatcher to:
correlate containers at the edge node with the critical devices and/or other devices at the edge node, and
dispatch the received tasks to the containers in the new order.

16. The computer program product of claim 15, wherein the operations further comprise:
in response to one or more of the tagged tasks being completed, causing the respective tagged tasks to be removed from the dependency list in real time.

17. The computer program product of claim 10, wherein the dependency list reflects relationships between the related tasks.

18. The computer program product of claim 10, wherein the edge node is connected to a cloud location having an edge controller and an API server.

19. A computer system comprising:
a processor set;
one or more computer-readable storage media; and
program instructions stored on the one or more storage media to cause the processor set to perform operations comprising:
analyzing tasks received in an order at an edge node having one or more critical devices;
adding tags to ones of the received tasks that use the critical devices;
setting ones of the tagged tasks that use a same one of the critical devices as related tasks;
causing the tagged tasks to be added to an active dependency list;
causing an execution plan to be generated for the received tasks based at least in part on the order in which the tasks were received and the dependency list; and
causing the received tasks to be dispatched to the critical devices as outlined in the execution plan.

20. The computer system of claim 19, wherein the causing the execution plan to be generated for the received tasks comprises:
evaluating the order in which the tasks were received;
determining whether any of the related tasks have timestamps that are in a predetermined range of each other; and
in response to determining that two or more of the related tasks have timestamps that are in the predetermined range, rearranging the received tasks in a new order that reduces a total amount of time spent completing the received tasks.
